(19) United States
(12) Patent Application Publication
(10) Pub. No.: US 2017/0317823 A1
(43) Pub. Date: Nov. 2, 2017

(54) Zero Knowledge Encrypted File Transfer

(71) Applicants: Amish Gaganvihari Gandhi, San Jose, CA (US); Jayesh Patel, Poughkeepsie, NY (US)

(72) Inventors: Amish Gaganvihari Gandhi, San Jose, CA (US); Jayesh Patel, Poughkeepsie, NY (US)

(21) Appl. No.: 15/581,501

(22) Filed: Apr. 28, 2017

Related U.S. Application Data
(60) Provisional application No. 62/328,781, filed on Apr. 28, 2016.

(51) Int. Cl. H04L 9/08

(52) U.S. Cl. CPC H04L 9/0863; H04L 9/088; H04L 9/0897

(57) ABSTRACT

A method for secure file sharing comprises a sender encrypting content using a dynamic key and uploading the encrypted content and a share link which is sent to a server. The server stores the encrypted content until a request to decrypt the content is received from a receiver. The receiver selects the share link and decrypts the content using a partial dynamic key. Once content is decrypted, a download link is sent and decrypted content is conveyed to the receiver.

### CROSS-REFERENCE TO RELATED APPLICATION(S)

The present application claims priority to U.S. Provisional Patent Application No. 62/328,781 filed on Apr. 28, 2016, entitled “Secure File Share” the entire disclosure of which is incorporated by reference herein.

### BACKGROUND OF THE INVENTION

### 1. Field of Invention

The present invention relates to the field of data sharing and security services, and in particular without the need for exchanging a key or password beforehand.

### 2. Description of Related Art

Services available today to exchange data either rely on a unique link or exchange of passwords. This requires users to share the passwords in some fashion making the content vulnerable. The use of unique URLs does not provide any security as anyone with that URL can access the data, which is unencrypted.

Email is another way users exchange data, as it is convenient and ubiquitous but not efficient in exchanging secure data. Data on email servers can be stored forever increasing its chances of being compromised. Even if data is stored on servers, we hear weekly reports of servers of large Internet companies, banks and other data repositories, being compromised and sensitive data being disseminated or sold to unscrupulous

There are a number of services in the art available to store encrypted content online and also share. Most of them either require pre-registration, exchange of key, and/or sharing passwords. For someone sending secure files infrequently, pre-registration is undesirable. Consumers are reluctant to register as another userid and password must be remembered. Passwords are insecure and keys are a hassle to exchange without an automated key exchange system, so most users share links without any protection which makes the data vulnerable to interception.

In addition, many of the systems in the prior art encrypt data for transmission, but store the data in an unencrypted state. The data is processed in a web browser, where encrypted links are decrypted. Encrypted links contain fragment identifiers, and when opened, the web browser requests the encrypted data from servers, and sends the unencrypted URL (without the fragment) to the server. As the fragment itself will not be sent, the server cannot access the data sent, but the browser, by combining the encrypted file and the key contained in the fragment, is able to decrypt it.

In addition, many of the systems in the prior art encrypt data for transmission, but store the data in an unencrypted state. One system, TRESORIT, Tresorit's encrypted link is a web based, encrypted file sharing solution, wherein linked files have encryption such as the files synced with one of the Tresorit client's. The data is processed in a web browser, where encrypted links are decrypted. Encrypted links contain fragment identifiers, and when opened, the web browser requests the encrypted data from servers, and sends the unencrypted URL (without the fragment) to the server. As the fragment itself will not be sent, the server cannot access the data sent, but the browser, by combining the encrypted file and the key contained in the fragment, is able to decrypt it.

Another system, SYNC, has a randomly generated 2048 bit RSA private encryption key serving as the basis for all encryption. During account creation, a unique private key is generated and encrypted with 256 bit AES GCM, locked with the user's password. This takes place client-side, within the web browser or app. When a new share folder is created, the encryption key on each file within the share is encrypted with a unique 512 bit share key that is created specifically for the share. The share key is then encrypted with the RSA 2048 public key of each user, and held with the user's RSA private key.

Encrypted private keys are stored on SYNC's servers, and downloaded and decrypted locally by the desktop app, web panel or mobile apps after successful authentication. SYNC does not have access to a user's private key.

Unfortunately, each of these systems requires passwords, and stream or transmit unencrypted data from a server. As may be appreciated, data in transmit may be intercepted and viewed. In particular links are unencrypted and may provide access to sites that are secured by keeping the link or address secret.

Based on the foregoing, there is a need in the art for a secure data encryption and transmission system, that does not require pre-registration or sharing a key beforehand. Streaming data that is always encrypted in transmission, without the need for a key, also increases the security of the transmission and ease of use. Further, protection of links in transmission is important to security of the data and would be a preferred feature

### SUMMARY OF THE INVENTION

A method for secure file sharing comprising the steps of first, sending encrypted content by utilizing the following steps. First entering a sender's communication ID, wherein entering the sender's communication ID generates a unique code. Next, receiving a confirmation code and verifying the confirmation code followed by entering the communication IDs of one or more receivers. An encryption key is received from a database source and the content is encrypted. The encrypted content is uploaded along with a share link to the one or more receivers.

In an embodiment, the sender initiates the sending of content in a push configuration.

In an embodiment, at least one of the one or more receiver's initiates the sending in a pull configuration.

In an embodiment, the communication IDs are at least one of the following; an email, or an SMS.

A method for secure file sharing comprises one or more servers performing the steps of first receiving encrypted content which is stored on the server. A request to decrypt the encrypted content is then received.

In an embodiment, one or more keys are stored on a server.

In an embodiment, each of the one or more keys are partial keys.

In an embodiment, the server only receives encrypted content.

In an embodiment, the server decrypts the content even when if the share link is compromised.

A method for secure file sharing comprises a receiver receiving encrypted content by first, selecting a share link and receiving a unique code. The unique code is verified to decrypted the communication ID for a corresponding receiver. A second unique code is received and entered in order to verify the code. one or more dynamic keys and one or more receiver hashes are generated. The one or more receiver hashes matched and if successful, a download link is received in response to a database server decrypting the encrypted content.

In an embodiment, the unique code of the share link ensures it has not been tampered with, and wherein the share link ensures that a sender has not revoked access to the link.

In an embodiment, if the unique code is not verified, data is not transmitted to the receiver.

In an embodiment, if the unique code is verified, the database server sends one or more dynamic keys and the one or more receiver hashes.

In an embodiment, matching of the one or more receiver hashes decrypts the content.

In an embodiment, the decryption key is sent by the database server.

A computer-readable, non-transitory, programmable product, for implementing a secure file sharing between a sender and a receiver, comprises code executable by one or more processors, to cause the one or more processors to perform the following. First, input sender and receiver information in a memory, and associate one or more confirmation codes with encrypted content. The processor may also generate one or more unique codes and verify the one or more unique codes as well as generate an encryption key.

In an embodiment, encryption is accomplished by a process selected from a group consisting of; partial key, symmetric key, private key, public key, IPsec, PPTP, L2TP, and SSL.

In an embodiment, the step of verification is performed by hash matching.

In an embodiment, the processor is implemented as software as a service.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart of the high level data flow of the system, according to an embodiment of the present invention;

FIG. 2 is a functional view of the sharing process of the system, according to an embodiment of the present invention;

FIG. 3 is a flowchart of the file send process of the system, according to an embodiment of the present invention; and

FIG. 4 is a flowchart of the file receive process of the system, according to an embodiment of the present invention.

### DETAILED DESCRIPTION OF PREFERRED EMBODIMENTS

Data is often required to be transmitted online between recipients. If the data is private, it is vulnerable to interception and viewing by third-parties if not secured by encryption or otherwise. Emails may be intercepted and files transferred are often unencrypted and read by sophisticated data amalgamators and other repositories. It is therefore vital to protect sensitive information that is transmitted electronically. There are a number of services in the art available to store encrypted content online and also share. Most of them either require pre-registration, exchange of key, and/or sharing passwords.

The present system provides a convenient way to share the content while keeping it extremely secure during the transfer, without the need for the sender to share keys or passwords beforehand with the recipient(s). The technology is analogous to delivering the content in person, providing a safer alternative to the prior art. Just like SSL protocol, no one in between but only the intended recipients should be able to read the data. It should be as good as delivering the content in person. The process of exchanging the data is also straightforward and simple. Users should not be required to have the understanding of the technologies required for the encryption/decryption process. In a preferred embodiment, senders should not be required to create a password or any such artifact that would be required by the intended recipient to open the content as the password could be compromised.

Data content for transmission is encrypted before it leaves the sender's device and is stored on the server in an encrypted form. Only partial keys are stored on the server, and the partial keys do not enable the content to be decrypted. In an embodiment, the Data Encryption Key is used to encrypt the data. This key is then encrypted using another key which is sent to the server. The encrypted keys are sent to the user and second key is sent to servers, wherein the second key cannot decrypt the data but can only be used to decrypt the data encryption key.

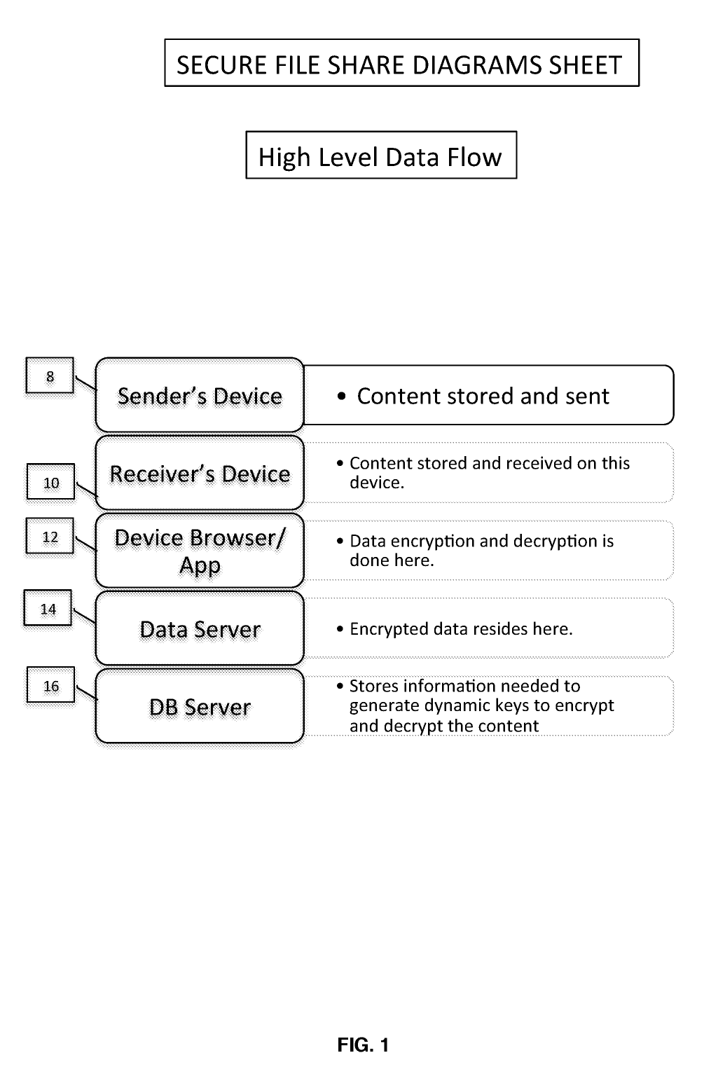

Preferred embodiments of the present invention and their advantages may be understood by referring to FIGS. 1-4, wherein like reference numerals refer to like elements. With reference to FIG. 1, the high level components are shown. Sender's device 8 and Receiver's device 10 are described, and the Sender's device 8 contains the content in un-encrypted and human-viewable format originally, whereas when the Receiver's device 10 receives the encrypted content to his/her device, the content is unencrypted for Receiver to be able to view it. A device browser and/or app software component(s) 12 exists and runs on Sender's device 8 and Receiver's device 10. When the Sender sends the content to the Receiver, the software component on Senders device encrypts the content and sends it to the server 14 in encrypted format. The content remains encrypted while residing on the server 14. The content is then downloaded from server 14 to Receiver's device in encrypted format and is finally decrypted by the Browser/App software component 12 on Receiver's device 10 for Receiver to view. The data server 14 is where encrypted content resides for sharing; so that the receiver can download it without requiring a direct connection directly to sender's device 8. Server 14 only has partial knowledge of the key and cannot construct it unless receiver tries to download the file. A database server 16 is used to store all the ancillary information required to generate the dynamic keys.

The software 12 utilizes the devices' 8, 10 computational power to effect the encryption and sends only encrypted content to server 14. The information required to generate the dynamic keys is stored on DB Server 16. Although at all points in the sharing process the server 14 does not have access or knowledge of the full key used to protect the content, this information is kept only on the device client 10 thus disallowing anyone but the intended recipient(s) to decrypt the data.

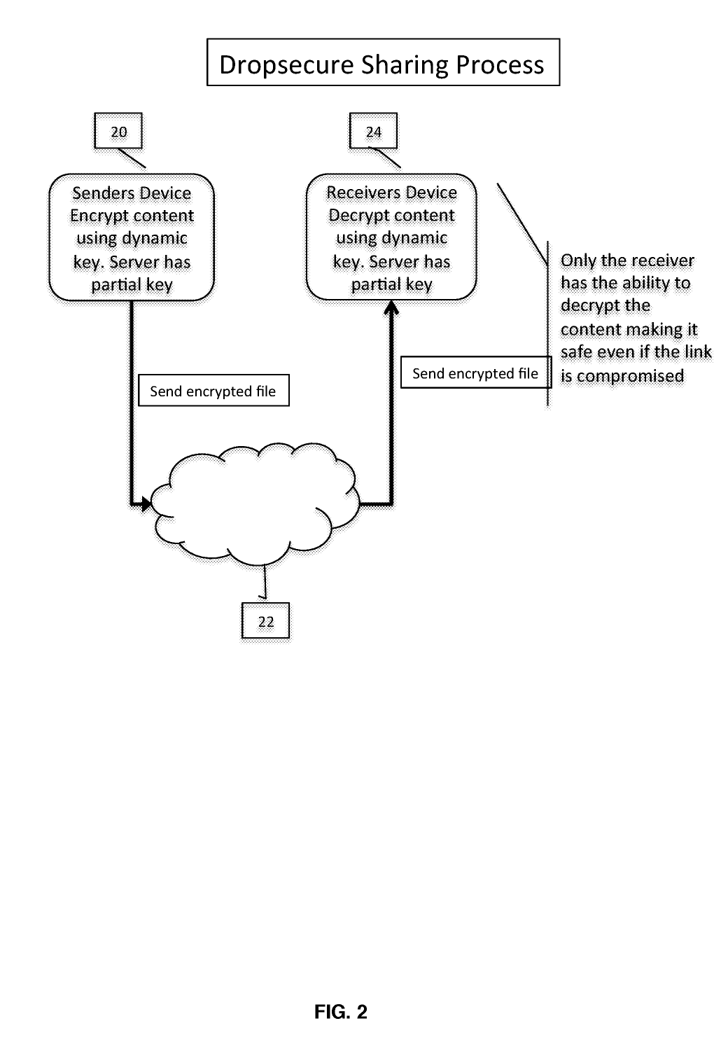

With reference to FIG. 2 the steps of the Secure Share Process are described. In step 20 the sender's device 8 encrypts the content using a dynamic key, wherein the server 14 has a partial key. At step 22 it sends the secure encrypted content to the server 14. The content is stored on the server 14 in an encrypted form, and at step 24 is transmitted to the receiver's device 10 in an encrypted form. The receiver's device decrypts the content using a dynamic key which was used to encrypt the document while sending, wherein the server 14 has a partial key. Only the receiver has the capability to decrypt the content, making it safe even if the link is compromised and the data intercepted.

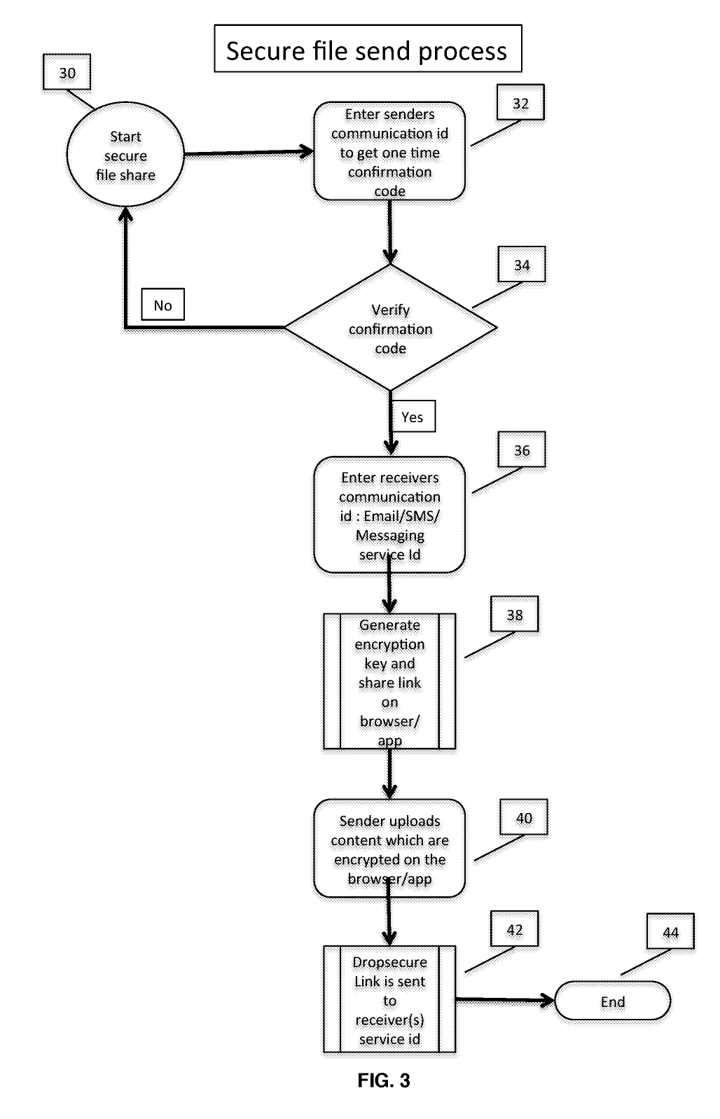

With reference to FIG. 3, the Sender Content Share Flow is described, containing the sequence of steps necessary to generate the dynamic keys and upload the encrypted file on the server. In step 30, the secure file share is started, which may be initiated by the sender in a push configuration, or by the receiver as pull configuration. In step 32 the sender's communication ID is entered to get a one time confirmation code. In step 34 the confirmation code is verified. In an embodiment, if the sender has a cell phone registered, an SMS may be sent with the code, or the code may be sent to their email. This one-time password may also be sent to a chat service like Slack, Facebook Messenger using the respective application program interface (“API”). If the verification is not successful, the system returns to step 30, initiating the secure file share. If verification is successful, at step 36 the receiver's communication ID is entered, which may comprise email, SMS or other messaging service IDs. In step 38 the encryption key is generated and the link is shared on the browser/app software with the sender's device 8. In step 40 the sender uploads or indicates the content to be uploaded within the system to the server 14. In step 42 the decryption link is sent to the receiver's service ID, and in step 44 the data transmission is complete, and is uploaded to the server.

For a user perspective, a user who is interested is sharing content starts the flow by entering their communication id, which could be email, SMS, or any other messaging service at step 32. They are then sent a one-time confirmation code to that id which they will need to enter to start sharing the file at step 34. On the sharing screen they will need to enter the receiver's communication id(s) and select the content they would like to share 36, 40. When they are ready to submit the content, it is first encrypted on the sender's device before leaving the sender's device 8. Server 14 only sees encrypted content and does not have the full key required to decrypt that content, however intended recipient(s) receive a unique link to download their content at step 42.

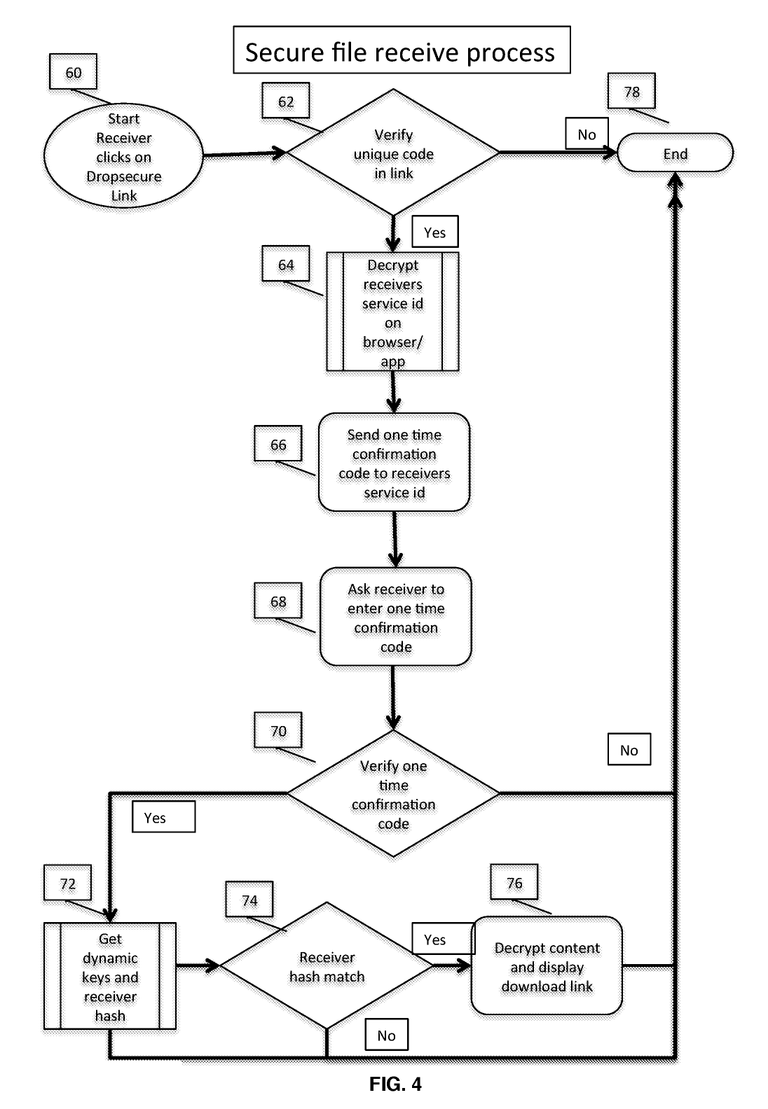

With reference to FIG. 4, the Receiver Content Share Flow is described, comprising the steps taken to verify the Receiver's identity and decrypt the dynamic keys to allow decryption of the share content. In step 60 the Receiver clicks on the secure link that was shared by the sender in step 42. In step 62 the unique code in the link is verified. In an embodiment, to verify, the email link contains unique code to make sure it is not tampered with and that the sender hasn't revoked the access. If verification is unsuccessful, the process is ended at step 78 and the file is not retrieved from the server. If the verification is successful, at step 64, the receiver's service ID is decrypted on the browser/app software component 12. At step 66, a one-time confirmation code is sent to the receiver's service ID. The Receiver can again register their cell phone, messenger or similar to receive the one-time password. The default is email, so if nothing is registered, the one-time password is sent to their email. In step 68, the receiver is requested to enter the one time confirmation code, and in step 70 the one time confirmation code is verified. If verification fails, the process ends at step 78. If verification is successful, at step 72 the server sends the keys to decrypt the dynamic keys and a receiver hash. In step 74 the receiver hash embedded in the email link is matched with that on the server which was stored when the file was sent. If the match fails, the process ends at step 78. If the hash match is successful, at step 76 the content is decrypted and a download link is displayed. The decryption key comes from the server, and the Receiver's email is hashed as explained above. Once the receiver device 10 receives the download link, the process ends at step 78.

From a Receiver point of view, each of the receivers gets an email with instructions on how to download the content at step 60. When the link is clicked, the link is first verified for its authenticity at step 62 and 64. If the link is valid then they are taken to service site where they are asked to enter a one-time confirmation code at step 70, which is sent to their choice of communication id. This protects from anyone having the link to access the secured content. If the one-time code matches, then server proceeds with sending the encrypted content to the device. The decryption keys are decrypted on the device and finally the content is served to the receiver 76.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope.

I claim:

1. A method for secure file sharing comprising the steps of:
a. sending encrypted content according to the steps of:
i. entering a sender's communication ID, wherein entering the sender's communication ID generates a unique code;
ii. receiving a confirmation code;
iii. verifying the confirmation code;
iv. entering the communication IDs of one or more receivers;
v. receiving an encryption key from a database source;
vi. encrypting content;
vii. uploading the encrypted content and a share link; and
viii. sending the share link to the one or more receivers.

2. The method of claim 1, wherein the sender initiates the sending of content in a push configuration.

3. The method of claim 1, wherein at least one of the one or more receiver's initiates the sending in a pull configuration.

4. The method of claim 1, wherein the communication IDs are at least one of the following; an email, or an SMS.

5. A method for secure file sharing comprising the steps of:
a. one or more servers performing the steps of:
i. receiving encrypted content;
ii. storing the encrypted content;
iii. receiving a request to decrypt the encrypted content;

6. The method of claim 2, wherein one or more keys are stored on a server.

7. The method of claim 6, wherein each of the one or more keys are partial keys.

8. The method of claim 2, wherein the server only receives encrypted content.

9. The method of claim 2, wherein the server decrypts the content even when if the share link is compromised.

10. A method for secure file sharing comprising the steps of:
a. receiving encrypted content according to the steps of
i. selecting a share link;
ii. receiving a unique code;
iii. verifying the unique code;
iv. receiving a decrypted communication ID for a corresponding receiver; cypher;
v. receiving a confirmation code;
vi. entering the confirmation code;
vii. verifying the confirmation code;
viii. generating one or more dynamic keys and one or more receiver hashes;
ix. matching the one or more receiver hashes; and
x. receiving a download link in response to a database server decrypting the encrypted content.

11. The method of claim 10, wherein the unique code of the share link ensures it has not been tampered with, and wherein the share link ensures that a sender has not revoked access to the link.

12. The method of claim 11, wherein if the unique code is not verified, data is not transmitted to the receiver.

13. The method of claim 11, wherein if the unique code is verified, the database server sends one or more dynamic keys and the one or more receiver hashes.

14. The method of claim 13, wherein matching of the one or more receiver hashes decrypts the content.

15. The method of claim 14, wherein the decryption key is sent by the database server.

16. A computer-readable, non-transitory, programmable product, for implementing a secure file sharing between a sender and a receiver, comprising code executable by one or more processors, to cause the one or more processors to do the following:
a. input sender and receiver information in a memory;
b. associate one or more confirmation codes with encrypted content;
c. generate one or more unique codes;
d. verify the one or more unique codes; and
e. generate an encryption key.

17. The computer-readable, non-transitory, programmable product in claim 16, wherein encryption is accomplished by a process selected from a group consisting of; partial key, symmetric key, private key, public key, IPsec, PPTP, L2TP, and SSL.

18. The computer-readable, non-transitory, programmable product in claim 16, wherein the step of verification is performed by hash matching.

19. The computer-readable, non-transitory, programmable product in claim 16, wherein the processor is implemented as software as a service.
